(19) United States
(12) Patent Application Publication
(10) Pub. No.: US 2010/0213775 A1
(43) Pub. Date: Aug. 26, 2010

(54) High power density generator

(75) Inventor: Majid Naghshineh, Wilmette, IL (US)

Correspondence Address: LAW OFFICES OF MICHAEL M. AHMADSHAHI, 600 ANTON BLVD., STE. 1100, COSTA MESA, CA, 92626, US

(73) Assignee: C.E. NIEHOFF & CO.

(21) Appl. No.: 12/380,272

(22) Filed: Feb. 24, 2009

(51) Int. Cl. H02K 9/06; H02K 3/00; H02K 11/04

(52) U.S. Cl. 310/62; 310/194; 310/68 D

(57) ABSTRACT

A high power density generator includes a rotor assembly, a rectifier assembly, and a cooling assembly configured in such a way so as to provide high electrical output power while retaining a small profile. The rotor assembly includes one or more rings configured to secure the main rotor windings to the main rotor poles by imparting a clamping force therebetween while conforming to the windings' profile allowing for operation at high RPM and high levels of shock and vibration. The rotor assembly may further include a rotating rectifier assembly positioned so as to reduce the moment arm between the mass centers of the rotor assembly and the drive-end bearing. The rectifier assembly comprises a rectifier housing and one or more rectifiers which are placed radially so as to dissipate heat directly into the airstream. The cooling assembly, comprising a fan and a shroud, is placed adjacent to the rectifier assembly providing immediate cooling of the rectifier.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a generator capable of producing high electrical output power while retaining a small profile. In particular, the present invention relates to a high power density generator, comprising a rotor assembly, a rectifier assembly, and a cooling assembly, that allow the generator to operate at high rotational speeds (RPMs) and elevated ambient temperatures while being subjected to high levels of shock and vibration.

### BACKGROUND

The present invention relates to a high power density generator that provides high electrical output power while retaining a small profile. The generator has been designed to operate at high RPMs and withstand high levels of shock and vibration. The generator comprises subassemblies that have been constructed to maximize mechanical strength and thermal efficiency. Additionally, the positions of the subassemblies have been arranged in such a way so as to achieve superior mechanical strength and thermal performance.

Generators used in modern vehicles, including automobiles, trains, ships, aircrafts, and spacecrafts are expected to produce high output power while becoming smaller in size. Additionally, such generators are expected to operate in hostile environment, such as those found in military applications. Specifically, these generators are expected to operate at high ambient temperatures, such as those encountered under the hood of a military vehicle, while being subjected to high levels of shock and vibration, such as those encountered when the vehicle drives on unpaved roads. Various generators have been designed to operate in such harsh environments. However, the divergent requirements of high electrical output power and small profile under these operating conditions have made the design rather challenging.

The generator's performance is directly affected by the mechanical integrity of its rotor assembly. In addition to the centrifugal forces resulting from the rotor's rotation, shock and vibration imparted by the vehicle on the generator requires a rugged rotor assembly. Exposure to sudden forces and moments results in high stresses that cause cracks and eventual fracture of the assembly. Vibration causes cyclic loading that leads to fatigue. Furthermore, fastened components, such as the rectifying devices, exposed to vibration tend to unfasten prematurely or lose close contact with their mating parts. The former leads to total failure of the rotor assembly while the latter causes excess heat.

One particular concern with high electrical output generators is the size and, hence, inertia of the rotor assembly. Such generators must include sufficiently large rotors in order to produce the necessary electrical output. The rotor assembly includes a main rotor with a plurality of main rotor poles and the associated main rotor windings that are mounted on a shaft and rotate at high speeds. Securing the main rotor windings to the main rotor poles is critical to the operation and longevity of the generator. Inadequate bond between the main rotor windings and main rotor poles can cause premature failures. Such failures are manifested in several forms. For instance, in high vibration environment, inadequate clamping force between the main rotor windings and main rotor poles can cause relative motion between the windings and the poles. This relative motion creates frictional forces that can destroy the coatings of the conductors in the main rotor windings giving rise to an electrical short. The relative motion also creates frictional heat that raises the effective operating temperature of the main rotor windings thereby reducing its electrical output. Consequently, an improvement in the bonding force between the main rotor poles and main rotor windings improves the mechanical and thermal performance of the generator.

The present invention offers a novel, yet, simple solution to this problem. In particular, the rotor assembly of the generator of the present invention includes a main rotor having a plurality of main rotor poles and associated main rotor windings. The rotor windings are fastened to the main rotor poles using one or more rings whose inner diameter conforms to the profile of the main rotor windings. This configuration eliminates the need for additional components that are commonly used to secure the main rotor windings to the main rotor poles, while providing superior clamping force between the main rotor poles and main rotor windings. It also simplifies the manufacturing process and hence reduces the manufacturing cost. Additionally, the main rotor windings may be made from conductors of rectangular cross section providing a highly compacted structure. In a preferred embodiment, two rings are used at both ends of the rotor assembly in order to secure the main rotor windings to the main rotor poles. Each ring is made from a one-piece solid ring whose inner diameter is machined to conform to the profile of the main rotor windings.

Another concern with high electrical output generators and their massive rotor assembly is their vibration characteristics. A generator's average life or mean time before failure (MTBF) is a direct function of its response to the vibration levels experienced by the rotor assembly. Specifically, transverse modes of vibration can be especially detrimental to the generator's bearings. Excessive rotor vibration has been well studied to cause bearing damage such as brinelling. Several solutions are well known in the art. One solution is to design the rotor in such a way so as to remove the rotor's natural modes of vibration away from the system excitation frequencies. Another solution is to reduce the amplitude of the system excitation frequencies. Yet another solution is to provide means to dampen the rotor's vibrations. The aforementioned rings of the rotor assembly of the disclosed generator can be used to reduce the amplitude of the system's excitation. In particular, the rings are made from metallic material whose mass may be advantageously modified to balance the rotor assembly thereby reducing the amplitude of the system vibration. For instance by drilling holes or slots in the rings, sufficient material may be removed in order to balance the rotor assembly for smooth operation.

The selection of the conductor, used to make the main rotor windings of the present invention, conforms to the overall scheme of designing a high power density generator. Although wires of different cross sections may be used, in a preferred embodiment wires of rectangular cross section are utilized in the main rotor windings in order to improve the generator's mechanical performance as well as its electrical output power. Conductors with rectangular cross section may be wound with greater force thereby providing greater mechanical strength. Such windings are ideal in high RPM applications as well as those that are subject to high levels of shock and vibration. Wires with rectangular cross section also facilitate windings with greater density thereby providing higher electrical output power.

The most massive component of a generator's rotor assembly is its main rotor. As such, the placement of the main rotor on the shaft is critical in the operation of the generator. Empirical data shows that any reduction in the distance between the mass centers of the main rotor and the bearing reduces the amplitude of vibration experienced by the bearing and thus increases the bearing life. Ordinarily the drive-end bearing is under heavier loads than the anti-drive-end bearing and it would be desirable to reduce the vibration levels of the drive-end bearing. Therefore, shortening the aforementioned moment arm between the main rotor and drive-end bearing substantially improves the operating condition of the drive-end bearing. Generators of the present type utilize one of self-excited and externally-excited generators in order to provide the main rotor with DC current for generation of electrical output current via the associated main stator windings. Both the self-excited and externally-excited generators comprise an exciter rotor which is also mounted on the shaft of the rotor assembly. Consequently, an improvement in the placement of the exciter rotor improves the mechanical performance of the drive-end bearing of the generator.

The disclosed generator further may include one of a self-excited or externally-excited generator, commonly used for generation of DC current for the main rotor. In a preferred embodiment, an externally-excited generator is utilized. The externally-excited generator includes an exciter rotor that is part of the rotor assembly. The axial position of the exciter rotor has been chosen to reduce the moment arm between the main rotor and the generator's drive-end bearing. Specifically, the exciter rotor has been placed after the main rotor and away from the generator's drive-end housing, making it possible to reduce the distance between the main rotor and the generator's drive-end bearing. This configuration reduces the amplitude of vibration on the drive-end bearing, thereby, increasing the bearing life.

Operating temperature of individual components of the generator is of great importance to the generator's performance. Of special concern are the rectifiers, commonly used to rectify the generator's AC current into DC current, and the bearings that support the rotor assembly. Rectifiers operating at high temperature can be damaged and subsequently may generate even more heat. Generators that are air cooled use bearings that include grease for lubrication purposes. High temperatures adversely affect the grease, reducing its viscosity. Rolling bearings rely heavily on proper grease viscosity. Bearings that operate at high temperatures are, therefore, prone to premature failure. Consequently, any improvement in the operating temperature of individual components of the generator, such as the aforementioned rectifiers and bearings, is greatly desired.

The placement of the rectifiers and anti-drive-end bearing of the disclosed generator is designed to lower their operating temperature. The rectifiers have been placed in a separate rectifier housing that improves heat transfer. Specifically, the rectifiers are placed radially and in close proximity to the fin-like protrusions of the rectifier housing, thereby, reducing the effective distance over which the heat, generated by the rectifiers, must be conducted. The anti-drive-end bearing is also placed in a separate housing and away from the rectifiers in order to lower its operating temperature.

Temperature distribution throughout the generator is also of paramount concern. As stated above, most of the components that make up the generator are prone to premature failure if their operating temperature is above a threshold value. Distribution of temperature within the generator is a function of the placement of individual components relative to one another and the inlet airstream. As a result, careful placement of heat generating components of the generator relative to those that are more prone to failure due to high temperatures can substantially improve the life and performance of the generator.

The generator of the present invention is constructed from components that are positioned so as to achieve the best temperature distribution. Specifically, the generator's components that generate the greatest heat have been placed in close proximity to fresh inlet airstream and those that are more prone to failure due to high temperature have been placed away from the heat generating components. As discussed above, the rectifiers generate the most heat and are themselves more prone to failure due to high temperature. The cooling assembly of the present invention, which includes a fan and shroud, has been positioned adjacent to the rectifiers and brings cool air to the rectifier housing for improved heat transfer between the rectifiers and ambient air. The drive-end bearing has been positioned farthest from the rectifiers so as to minimize conductive heat transfer between the anti-drive-end housing and rectifier housing.

Consequently, there is a need for a high power density generator that 1) is small in size, 2) can produce high electrical output power, 3) operate at high ambient temperatures, 4) distribute heat advantageously throughout the generator, and 5) withstand large shocks and vibrations. Although various systems have been proposed which touch upon some aspects of the above problems, they do not provide solutions to the existing limitations in providing a high power density generator with the above mentioned characteristics.

For example, the Hein et al. patent, U.S. Pat. No. 6,583,532 (“Hein”), discloses a rotating electrical machine having a permanent magnet rotor whose stator windings utilize a thermally conductive solid ring to provide a thermal bridge between the windings' ends the stator housing. The ring is constructed from individual thin laminates and do not come into contact with the windings' ends. Initially, Hein's rings are limited to thermally conductive material whereas the rings that are utilized in the disclosed generator are not so limited. Also, Hein's rings do not provide the clamping force required to secure the windings to the stator housing. In fact, they require a gap between the rings and the windings' ends such that resin can be poured into the gap. Additionally, the rings are made from individual laminates so as to accommodate the changing profile of the windings' ends and thus difficult to assemble. Heins' rings simply provide a thermal bridge and cannot withstand the centrifugal forces of a high-speed rotor operating in excessive levels of shock and vibration.

In Blakelock et al, U.S. Pat. No. 6,218,759 (“Blakelock”), a support mechanism is disclosed to support the windings in the unsupported region of the stator core and to provide a radial outward force on the windings in that region. Initially, the mechanism comprises multiple components including a core end support ring, an end wedge, a slide, a ripple spring, and one or more filler strip, whereas the disclosed ring of the present invention may be constructed from a single-piece ring. Furthermore, Blakelock's assembly is designed to impart only radial force on the windings, whereas the ring included in the disclosed generator provides clamping force in both axial and radial directions. Finally, the rings of the disclosed generator rotate with the generator's rotor at high speeds and are therefore subjected to the same centrifugal forces as the rotor in addition to the environmental shock and vibration, whereas Blakelock's support mechanism provides support for a stationary stator windings and because of its multi-component structure, it is unlikely to withstand the aforementioned operating loads.

Lafontaine et al., U.S. Pat. No. 7,122,923 (“Lafontaine”), discloses a compact permanent magnet high power alternator that includes mechanisms to prevent the rotor magnets from clashing with the stator by minimizing rotor displacements, and a cooling system that directs coolant flow into thermal contact with the stator windings and magnets by providing passage way through the stator core. Lafontaine's clash avoidance mechanism comprises a bumper operative to restrict the displacement of the rotor but does not operate in the same way as the rings of the disclosed generator. Furthermore, the cooling system of Lafontaine's alternator requires passageways through the stator core whereas the cooling system of the present generator does not require such passageways.

Modern dynamoelectric machines, such as a high power density generator used in vehicle electrical systems, are required to produce high electrical output power while being compact, light weight, efficient in heat transfer, and mechanically strong. These characteristics counteract in that reduced size and weight limit mechanical strength and efficient transfer of heat. An optimal balance can be achieved by providing a robust rotor assembly, a superior heat distributing rectifier assembly, and an efficient cooling assembly. Additionally, the components that make up the generator can be positioned in such a way so as to improve the mechanical and thermal performance of the generator. The high power density generator of the present invention meets these requirements by incorporating assemblies that are mechanically strong and thermally efficient and positioning them in such a way so as to achieve the most favorable heat distribution throughout the generator.

### SUMMARY

The present invention discloses a high power density generator designed to produce high electrical output power while having an overall small dimension. The generator comprises subassemblies that have been optimized for operation in hostile environment, such as high ambient temperatures and elevated levels of shock and vibration. Specifically, the generator includes a rotor assembly, a rectifier assembly, and a cooling assembly, configured to provide high electrical output power while retaining a small profile.

The rotor assembly comprises a main rotor which includes a plurality of main rotor poles and the associated main rotor windings operative to produce a time-varying magnetic field. One or more rings are utilized to secure the main rotor windings to the main rotor poles while conforming to the profile of the main rotor windings. The strong bond facilitated by the rings enables the rotor assembly to operate at high RPMs. The rings also provide a means to balance the rotor assembly required for high RPM operation. In addition to providing a robust fastening and balancing mechanism, the rings simplify the manufacturing process and reduce cost by minimizing components. Specifically, the rings are configured to conform to the profile of the main rotor windings, thus providing a strong bond between the main rotor windings and main rotor poles and eliminating the need for wedge-type elements that are commonly used to accommodate the profile of the main rotor windings.

The rectifier assembly comprises a rectifier housing and one or more rectifiers operable to rectify the AC output current of the generator to DC current. The rectifier housing may be made from a one-piece construction or multiple sections. In a preferred embodiment, the rectifier housing is made from three separate sections that are fastened to the anti-drive-end housing of the generator. The rectifier housing includes fin-like protrusions designed to improve heat dissipation. The rectifiers are advantageously placed radially within the rectifier housing in order to reduce the distance over which the heat, generated by the rectifiers, must be conducted. This provides for additional improvement in the overall heat transfer characteristics of the generator. Additionally, the multi-section rectifier housing makes it easier to service the generator as individual sections may be repaired or replaced separately.

The cooling assembly includes a fan and shroud which directs the airflow over the rectifier assembly. Specifically, the shroud brings relatively cool ambient air to the rectifiers that are the main heat generating components of the generator. The fan is a radial fan with straight blades making the generator rotatable in both directions. In a preferred embodiment, the cooling assembly is positioned immediately adjacent to the rectifier assembly in order to efficiently cool the latter through convective heat transfer.

The components of the high power density generator of the present invention are also positioned within the generator in such a way so as to further improve its mechanical strength and thermal efficiency. Superior mechanical improvements are achieved by optimally placing the components in close proximity to one another so as to minimize the overall dimension of the generator, and greater thermal efficiency is attained by optimizing the medium through which conductive and convective heat transfer occur. In particular, the overall length of the generator is shortened by abutting the generator's drive-end housing, which encloses the main stator assembly, to the generator's anti-drive-end housing which encloses the exciter stator assembly, eliminating the need for the commonly used shell assembly. The generator's main rotor is positioned in close proximity to the drive-end bearing in order to minimize the moment arm between their mass centers. The cooling assembly is positioned adjacent to the rectifier assembly in order to bring into contact fresh ambient air with the rectifiers.

In one aspect, a generator is disclosed comprising a rotor assembly including a shaft, a main rotor with one or more main rotor poles, one or more main rotor windings wound around the main rotor poles, and one or more rings, conformable to the main rotor windings' profile and operable to impart a clamping force to secure the main rotor windings to the main rotor poles. Preferably the generator is a brushless alternator whose main rotor windings are constructed from conductors of rectangular cross section. In a preferred embodiment, the rings are further made from one-piece solid rings. The rings may provide the clamping force via one or more studs threaded at one or both ends and associated nuts operative to engage the threads. In another embodiment, the clamping force is created via a fastening fit such as an interference fit or shrink fit. Preferably, the rings further comprise one or more holes operative to balance the rotor assembly.

In another aspect, a generator is disclosed comprising a rotor assembly including a shaft, a main rotor with one or more main rotor poles, one or more main rotor windings wound around the main rotor poles, and one or more rings, conformable to the main rotor windings' profile and operable to impart a clamping force to secure the main rotor windings to the main rotor poles. The generator may further comprise an exciter generator in order to provide DC current to the main rotor windings. A self-excited or an externally-excited generator may be utilized to provide the DC current. The main rotor may be advantageously placed between the exciter generator and a drive-end housing of the generator in order to minimize the moment arm between the mass centers of the rotor assembly and the generator drive-end bearing. Preferably, the self-excited generator is a permanent magnet generator comprising an exciter rotor assembly mounted on the shaft. Preferably, the externally-excited generator is a battery-excited generator comprising an exciter rotor assembly mounted on the shaft. Preferably, the exciter rotor assembly comprises a rotating rectifier assembly.

In another aspect, a generator is disclosed comprising a rotor assembly including a shaft, a main rotor with one or more main rotor poles, one or more main rotor windings wound around the main rotor poles, and one or more rings, conformable to the main rotor windings' profile and operable to impart a clamping force to secure the main rotor windings to the main rotor poles. The generator may further comprise a rectifier assembly, including a rectifier housing having heat sinks with flat surfaces and fins. In a preferred embodiment, the rectifier assembly comprises modular rectifiers operable to convert AC current into DC current. The one or more rectifiers are radially coupled with the one or more flat surfaces of the heat sink in order to dissipate heat directly into the one or more fins.

In another aspect, a generator is disclosed comprising a rotor assembly including a shaft, a main rotor with one or more main rotor poles, one or more main rotor windings wound around the main rotor poles, and one or more rings, conformable to the main rotor windings' profile and operable to impart a clamping force to secure the main rotor windings to the main rotor poles. The generator may further comprise a cooling assembly including a fan, mounted on the shaft and adjacent to the rectifier assembly, and a shroud enclosing the fan. In a preferred embodiment, the fan is a radial fan and the shroud, containing a bore, is configured to direct airflow through the bore and over the one or more fins of the rectifier assembly. The generator may further comprise a voltage regulator operable to regulate the output voltage of the generator at a regulation voltage.

In another aspect, a generator is disclosed comprising a drive-end housing, an anti-drive-end housing, a rectifier assembly, a rotor assembly, and a cooling assembly, positioned in such a way so as to enhance the generator's mechanical and thermal performance. These components are positioned as follows: the anti-drive-end housing is disposed adjacent to the drive-end housing; the rectifier assembly is disposed adjacent to the anti-drive-end housing; the rotor assembly is enclosed within the drive-end housing and anti-drive-end housing; the main rotor of the rotor assembly is disposed between the drive-end housing and the rotor assembly's exciter rotor assembly; and the cooling assembly is disposed adjacent to the rectifier assembly. Preferably, the drive-end housing encloses a main stator assembly and comprises a first bore, concentric to an outer diameter of the drive-end housing, which encloses a first bearing. Preferably, the anti-drive-end housing encloses an exciter stator assembly and comprises a second bore, concentric to an outer diameter of the anti-drive-end housing, which encloses a second bearing. Preferably, the rectifier assembly includes one or more rectifiers which operate to convert alternating current, generated by the main stator assembly, into direct current. Preferably, the rotor assembly is disposed between the first and second bearing and comprises a shaft which is inserted in the first and second bearing, a main rotor including one or more main rotor poles and the associated one or more main rotor windings wound around the one or more main rotor poles and operative to produce a time-varying magnetic field, an exciter rotor assembly operative to generate field current in the main rotor windings via the exciter stator assembly, and one or more rings disposed at one or both ends of the main rotor wherein the one or more rings are configured to impart a clamping force to secure the one or more main rotor windings to the one or more main rotor poles while conforming to the one or more main rotor winding's profiles. Preferably, the cooling assembly comprises a fan which is mounted on the shaft and a shroud which encloses the fan and includes a third bore wherein the cooling assembly is configured to direct airflow in the direction from the anti-drive-end housing to the drive-end housing.

In another aspect, a generator is disclosed comprising a drive-end housing, an anti-drive-end housing, a rectifier assembly, a rotor assembly, and a cooling assembly, positioned in such a way so as to enhance the generator's mechanical and thermal performance. Preferably, the anti-drive-end housing of the generator comprises two output terminals for providing voltage regulated electrical output power which may be configured to be electrically isolated.

### BRIEF DESCRIPTION OF THE DRAWINGS

FIG. 1 shows an exploded view of the generator of the present invention illustrating the rotor, rectifier, and cooling assemblies and their arrangement according to a preferred embodiment.

FIG. 2 shows a perspective view of a rotor assembly according to a preferred embodiment.

FIG. 3 shows three different views of the main rotor and associated main rotor windings secured by two solid rings according to a preferred embodiment.

FIG. 4 shows a perspective view of a main rotor winding using a conductor of rectangular cross section according to a preferred embodiment.

FIG. 5 shows several views of a solid ring used to secure the main rotor windings to the main rotor poles according to a preferred embodiment.

FIG. 6 shows a perspective view of a rectifier assembly according to a preferred embodiment.

FIG. 7 shows a schematic representation of airflow, generated and directed by the cooling assembly, over the rectifier assembly according to a preferred embodiment.

### DETAILED DESCRIPTION OF THE PRESENTLY PREFERRED EMBODIMENTS

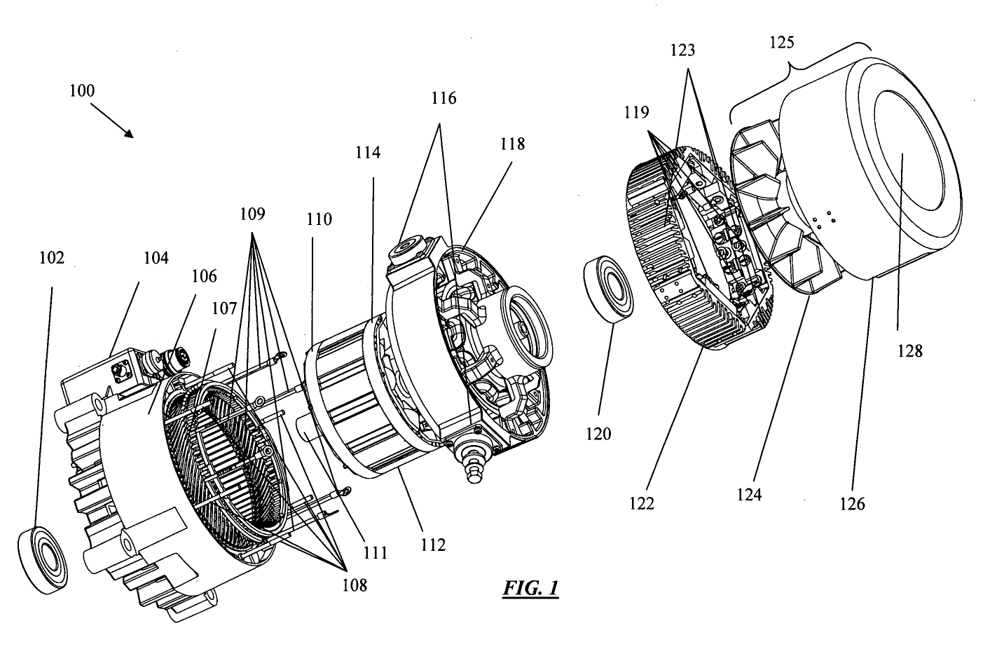

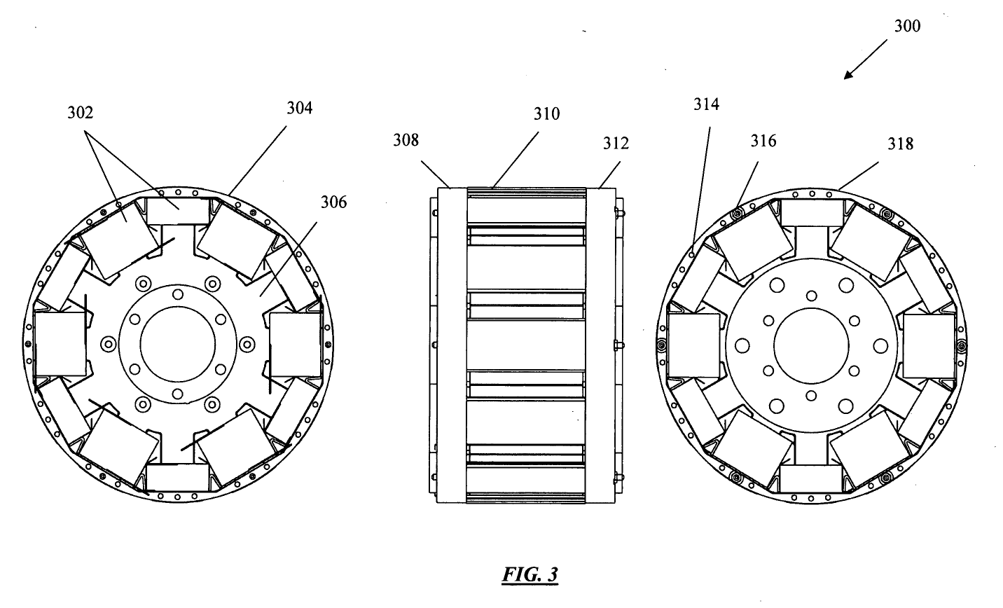

FIG. 1 depicts a generator 100 including a main stator assembly 107, rotor assembly 112, rectifier assembly 122, and cooling assembly 125 which includes a radial fan 124 and shroud 126. The generator 100 further includes a drive-end housing 106, a drive-end bearing 102, an anti-drive-end housing 118, and an anti-drive-end bearing 120. The main rotor windings (shown in FIG. 3) are secured to the main rotor poles (shown in FIG. 3) via two solid rings 110 and 114. One or more studs 108 and nuts (not shown) are utilized to create a clamping force to secure the main rotor windings to the main rotor poles. The rings 110 and 114 are configured to conform to the profile of the main rotor windings. According to a preferred embodiment, the generator subassemblies and their components are positioned according to the arrangement shown in FIG. 1. A voltage regulator 104 operates to regulate the output voltage of the generator output current at a regulation voltage which is available via output terminals 116.

The generator 100 is a high power density generator that generates approximately 18 KW of steady state DC electrical power at room temperature while its outer diameter and overall length are kept within about 9 and 11 inches, respectively. Specifically, the generator 100 generates electrical power via the interaction between a time-varying magnetic field, generated by the rotor assembly 112, and one or more main stator windings included in the main stator assembly 107 disposed within the drive-end housing 106.

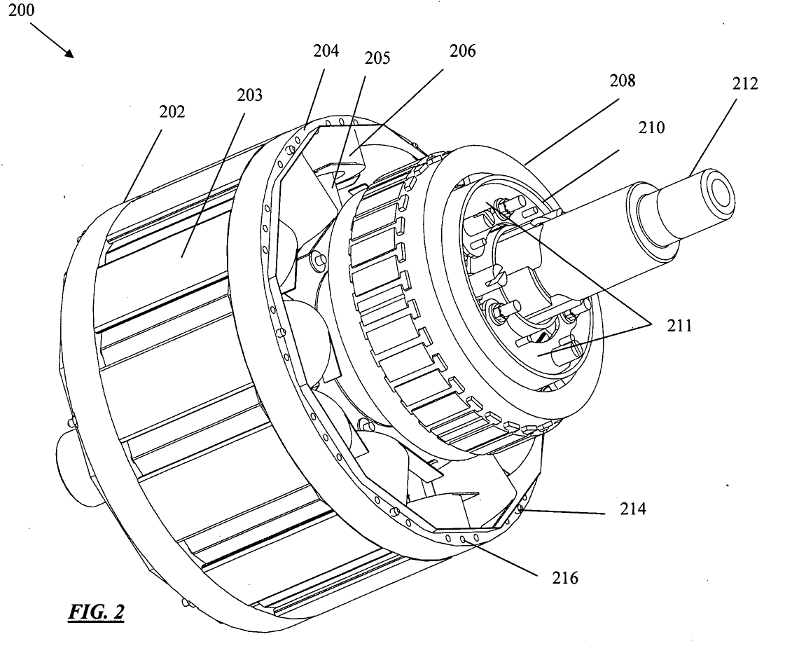

The rotor assembly 112 comprises a plurality of main rotor poles and main rotor windings (shown in FIGS. 2 and 3). An externally excited generator (partially shown in FIG. 2) provides the main rotor windings with DC current that generates the time-varying magnetic field. The externally excited generator comprises an exciter rotor assembly (shown in FIG. 2) which interacts with the magnetic field generated by the exciter stator assembly (not shown) disposed in the anti-drive-end housing 118. Specifically, the magnetic field interaction between the exciter rotor windings and exciter stator windings produces an AC current in the exciter rotor windings. This AC current is converted into DC current via a rotating rectifier assembly (shown in FIG. 2) which in turn is fed to the main rotor windings. The rotor assembly 112 is secured within the generator 100 by the drive-end bearing 102 and anti-drive-end bearing 120.

According to a preferred embodiment, a six phase AC current is generated by the main stator assembly 107 and is available through output cables 109. The AC current is converted into DC current by use of the rectifier assembly 122. Specifically, full-wave rectification is achieved by utilizing rectifiers 119 to rectify the AC current and produce DC current whose voltage is regulated by the voltage regulator 104. According to a preferred embodiment, the rectifier assembly 122 includes a rectifier housing 123 which is constructed from three separate pieces 123.

The cooling assembly 125, comprising a radial fan 124 and shroud 126, cools the generator 100 to maintain a suitable steady state temperature. The radial fan 124 includes straight blades which are ideal for bi-directional operation. The shroud 126 comprises a central bore 128 where inlet air enters the generator 100. Specifically, the cooling assembly 125 is configured to steer the inlet air directly over and around the fin-type protrusions of the rectifier assembly 122.

In addition to achieving superior mechanical strength, the subassemblies and individual components of the generator 100 have been positioned in such a way so as to optimize the overall size and temperature distribution throughout the generator 100. Specifically, the axial, radial, and angular positions of the subassemblies and components have been designed to achieve a finer balance between reduction in size and superior heat transfer.

The main stator assembly 107 is disposed within the drive-end housing 106 which abuts the anti-drive-end housing 118 eliminating the need for the commonly used shell assembly thereby reducing the overall length of the generator 100. The rectifier assembly 122 is positioned adjacent but separate from the anti-drive-end housing 118 which encloses the anti-drive-end bearing 120. This configuration allows the heat, generated by the rectifiers 119, to dissipate into the rectifier housing 123 rather than the anti-drive-end housing 118, thereby greatly reducing the operating temperature of the anti-drive-end bearing 120. The rectifiers 119 are placed radially within the rectifier housing 123 to reduce the effective length through which heat is conducted from the rectifiers 119 to the fins of the rectifier housing 123, thereby improving the overall heat transfer. The cooling assembly 125 is placed in immediate vicinity of the rectifier assembly 122 so that the latter is exposed to fresh inlet air brought in by the former.

The rotor assembly 122 is secured within the generator 100 via the drive-end bearing 102 and anti-drive-end bearing 120. The rotor assembly 122 comprises main rotor windings that are wound around the main rotor poles and is one of the more massive subassemblies within the generator 100. The rotor assembly 122 comprises a shaft 111 which is inserted into the drive-end bearing 102 and anti-drive-end bearing 120 and rotates at varying RPMs, accelerating and decelerating throughout its operating conditions, subjecting it to various forces in axial, radial, and angular directions. As the generator 100 is further exposed to high levels of shock and vibration during operation, the rings 110 and 114 securely fasten the main rotor windings to the main rotor poles of the rotor assembly 122. The rings 110 and 114 further contain adequate material to be advantageously used to balance the rotor assembly 122. For instance, material can be removed from the rings 110 and 114 by drilling one or more holes in the rings 110 and 114. In addition to providing superior mechanical performance, the rings 110 and 114 greatly reduce the manufacturing process of the generator 100 by eliminating the need for additional components, such as wedge-type elements that are commonly used to accommodate the profile of the main rotor windings.

The rotor assembly 112 may further comprise an exciter rotor of a self-excited or an externally excited generator (shown in FIG. 2). The axial location of the exciter rotor has been shown to greatly impact the performance of the drive-end bearing 102. Specifically, it has been shown that any reduction in the distance between the mass centers of the main rotor of the rotor assembly 112 and the drive-end bearing 102 reduces the amplitude of vibration experienced by the bearing and thus increases the bearing life. Accordingly, the main rotor is located between the drive-end bearing 102 and exciter rotor so as to minimize the distance between their mass centers.

FIG. 2 depicts a perspective view of a rotor assembly 200 that may be used in the generator 100. The rotor assembly 200 comprises a shaft 212, main rotor 203 including a plurality of main rotor poles 205 that is mounted on the shaft 212. A plurality of main rotor windings 206 are wound around the main rotor poles 205 and produce a time-varying magnetic field as the rotor 200 rotates around the axis of the shaft 212. This time-varying magnetic field produces an AC current in the associated main stator windings of a main stator assembly such as the main stator assembly 107. The magnetic field is produced via either a self-excited generator or an externally-excited generator whose exciter rotor assembly includes an exciter rotor 208 and rotating rectifier assembly 210.

According to a preferred embodiment, a self-excited generator is used in the generator 100 whose exciter stator assembly (not shown) is disposed within the anti-drive-end housing 118. As the rotor assembly 200 rotates around the axis of the shaft 212, an AC current is generated by the exciter rotor windings. The rotating rectifier 210 comprises one or more rectifiers 211 that convert the AC current into DC current for the main rotor windings 206 which generates the aforementioned time-varying magnetic field. As stated above, the exciter rotor assembly has been axially located as depicted in FIG. 2 so as to place the main rotor 203 closer to the drive-end bearing 102, thereby reducing the amplitude of vibration experienced by the drive-end bearing.

FIG. 3 shows three different views of a main rotor 300 of a rotor assembly such as the rotor assembly 200. According to this embodiment, the main rotor 300 comprises 12 main rotor poles 306 and 12 main rotor windings 302 which are wound around the main rotor poles 306 according to two different lengths. The main rotor poles 306, shown in the side view as element 310, are made from individual laminates commonly used in this type of generators. Rings 308 and 312 are used to secure the main rotor windings 302 to the main rotor poles 310 by creating a clamping force. The rings 308 and 312 may be made from one or more one-piece solid rings. A plurality of studs such as the studs 108 shown in FIG. 1 and associated nuts (not shown) can be used to create the clamping force. According to this preferred embodiment, a plurality of holes 316 can be used to accommodate the studs 108. In a different embodiment, the clamping force may be created through a fastening fit, such as an interference fit or shrink fit. Holes 314 may be used to remove material from the rings 308 and/or 312 to balance the rotor assembly.

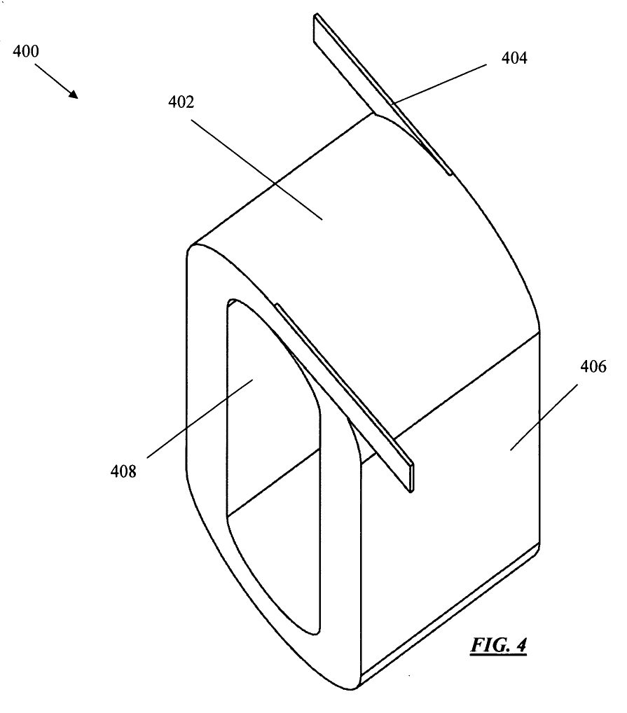

FIG. 4 shows a preferred embodiment of a winding 400 of a main rotor windings such as the main rotor windings 302. According to this embodiment, the conductor 404 is of rectangular cross section. The winding 400 comprises two flat surfaces 406 and two convex surfaces 402. The inside surface 408 is in contact with the main rotor poles. The rings, such as the rings 308 and 312 are made to conform to the profile of the winding 400. For instance, the inside diameter of the rings 308 and 312 can be machined to conform to the profile of the winding 400 regardless of whether the surface is flat or curved. This ensures intimate contact between the rings 308 and 312 and each of the windings 400 of the main rotor windings 302. This configuration protects the main rotor windings 302 against high levels of shock and vibration during operation.

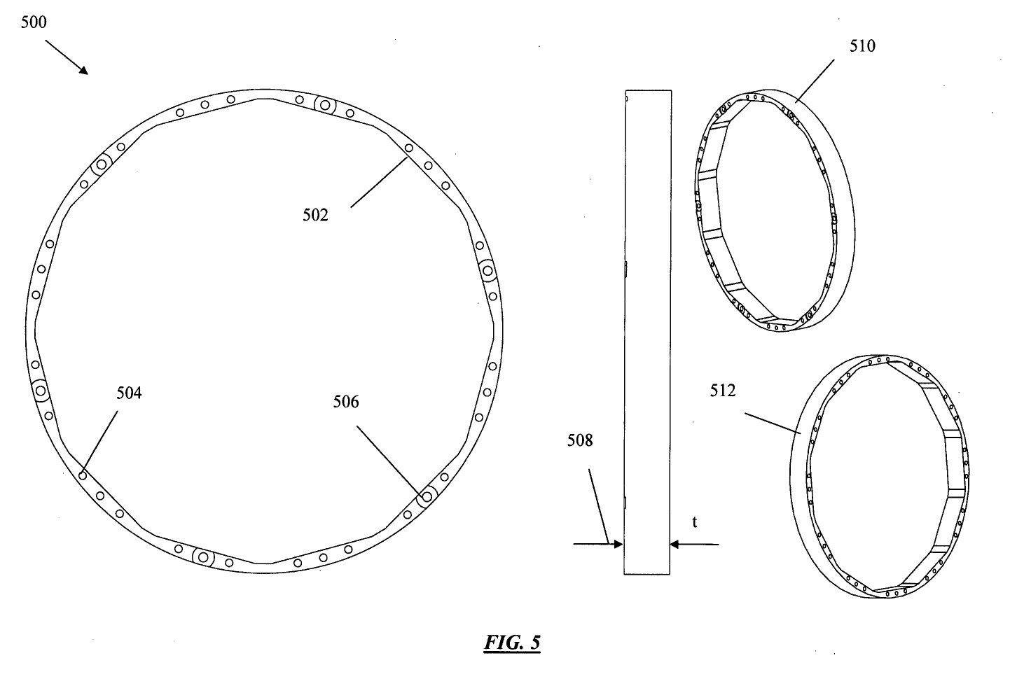

FIG. 5 shows several views of a ring 500 that is used to secure the main rotor windings 302 to the main rotor poles 306. According to this preferred embodiment, the ring 500 is made from a one-piece solid ring of thickness t, 508. Two such rings 510 and 512 would be used for this purpose. The inner diameter of the ring 500 is machined to create 12 flat surfaces 502 to conform to the flat surface of the main rotor windings 302. According to another embodiment, the inner diameter of the ring 500 may be machined to create surfaces of different profiles. For instance, the inner diameter maybe machined to conform to a curved profile of a winding, such as the profile 402 of the winding 400. Holes 504 are used to remove material from the rings 510 and 512 to balance the rotor assembly, while holes 506 are used to insert the studs 108 through the rings 510 and 512 to securely fasten the main rotor windings 302 to the main rotor poles 306.

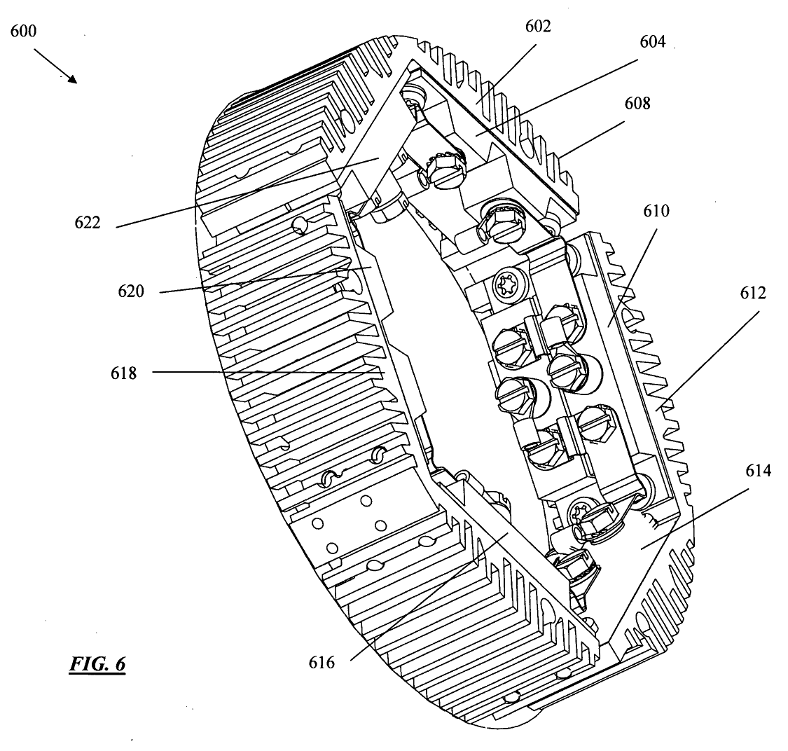

FIG. 6 shows a perspective view of a rectifier assembly 600 according to a preferred embodiment. The rectifier assembly 600 comprises a rectifier housing which may be constructed from a single or multiple pieces. According to a preferred embodiment, the rectifier assembly 600 comprises a rectifier housing which is made from three (3) separate pieces 602, 612, and 618. Each piece comprises one or more fin-type protrusions, such as the protrusion 608, that operate as heat sinks. Each piece further comprises two flat surfaces where two rectifiers may be attached, such as the rectifiers 604, 610, 614, 616, 620, and 622. The rectifiers are placed radially as depicted in FIG. 6 so as to minimize the distance over which heat, generated by the rectifiers, is conducted.

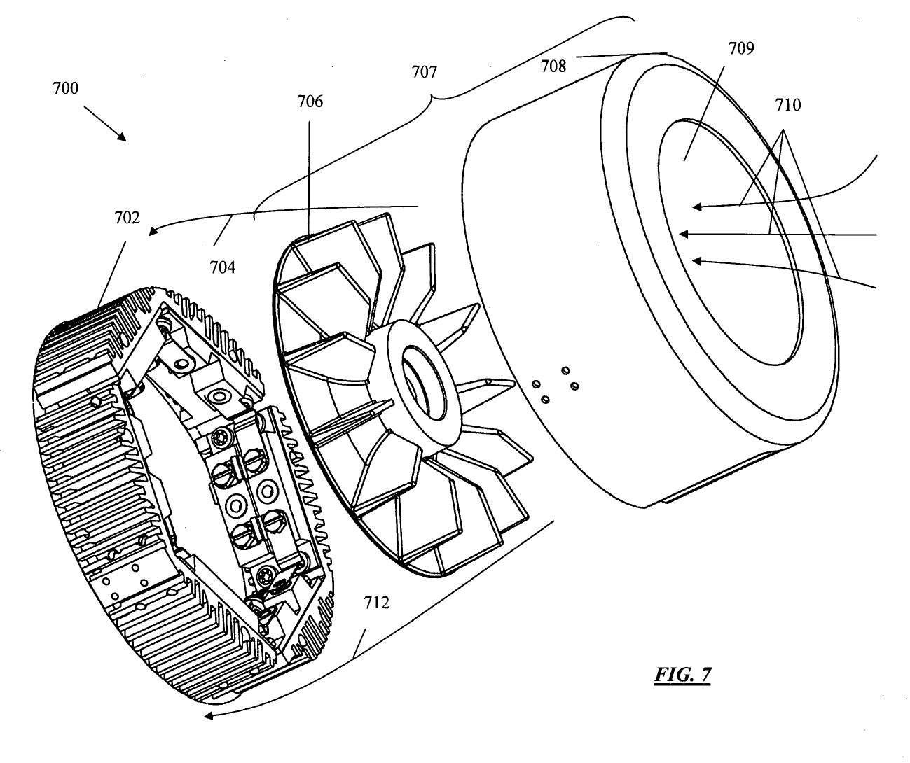

FIG. 7 shows depicts a combination 700 of a cooling assembly 707 and rectifier assembly 702. The cooling assembly 707 is positioned adjacent to the rectifier assembly 702 so that the latter is exposed to the fresh inlet air generated by the former. Accordingly, the rectifiers can dissipate a greater amount of heat and, thus, operate at a lower temperature. According to this preferred embodiment, the cooling assembly 707 comprises a radial fan 706 and a shroud 708. The shroud 708 comprises a central bore 709 where ambient air 710 enters the generator 100. According to another embodiment, a duct (not shown) may be attached to the shroud 708 where cooled air can enter the generator 100. The ambient air 710 is directed by the shroud 708 to pass directly through the rectifier assembly 702 as shown by streamlines 704 and 712. The radial temperature distribution of such streamlines increases from the center of the shroud 708 to its outer diameter. Accordingly, the rectifiers of the rectifier assembly 702 are exposed to cooler air, thereby, more efficiently dissipating the heat through convective heat transfer.

The foregoing discloses a generator that can produce high electrical output power while remaining small in size. The generator includes subassemblies that have been constructed and positioned in such a way so as to maximize the mechanical strength and thermal efficiency. Specifically, the generator comprises a rotor assembly, rectifier assembly, and cooling assembly that have been constructed and assembled to operate at high RPMs and excessive levels of shock and vibration. The generator's subassemblies and components have been positioned so as to achieve the most favorable temperature distribution throughout the generator.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A generator, comprising:
(a) a rotor assembly, comprising:
(i) a shaft;
(ii) a main rotor, including one or more main rotor poles, mounted on the shaft;
(iii) one or more main rotor windings wound around the one or more main rotor poles and operative to produce a time-varying magnetic field; and
(iv) one or more rings disposed at one or both ends of the main rotor;
wherein the one or more rings are configured to impart a clamping force to secure the one or more main rotor windings to the one or more main rotor poles while conforming to the one or more main rotor winding's profiles.

2. The generator of claim 1, wherein the generator is a brushless alternator.

3. The generator of claim 1, wherein the one or more main rotor windings comprise conductors of rectangular cross section.

4. The generator of claim 1, wherein the one or more rings comprise one or more one-piece solid rings.

5. The generator of claim 1, wherein the one or more rings are configured to impart the clamping force via one or more holes operative to receive one or more studs threaded at one or both ends and one or more nuts operative to engage the threaded ends of the one or more studs.

6. The generator of claim 1, wherein the one or more rings are configured to impart the clamping force via a fastening fit.

7. The generator of claim 6, wherein the fastening fit comprises at least one of an interference fit and shrink fit.

8. The generator of claim 1, wherein the one or more rings further comprise one or more holes operative to balance the rotor assembly.

9. The generator of claim 1, wherein the generator further comprises at least one of a self-excited and externally-excited generator and wherein the main rotor is disposed between a drive-end of the generator and the at least one of the self-excited and externally-excited generator.

10. The generator of claim 9, wherein the self-excited generator is a permanent magnet generator comprising an exciter rotor assembly mounted on the shaft.

11. The generator of claim 9, wherein the externally-excited generator is a battery-excited generator comprising an exciter rotor assembly mounted on the shaft.

12. The generator of claim 1 1, wherein the exciter rotor assembly comprises a rotating rectifier assembly.

13. The generator of claim 1, further comprising:
(b) a rectifier assembly, comprising:
(i) a rectifier housing including a heat sink, wherein the heat sink comprises one or more flat surfaces and one or more fins; and
(ii) one or more rectifiers radially coupled with the one or more flat surfaces of the heat sink;
wherein the one or more rectifiers are configured to dissipate heat directly into the one or more fins.

14. The generator of claim 13, further comprising:
(c) a cooling assembly, comprising:
(i) a fan mounted on the shaft and adjacent to the rectifier assembly; and
(ii) a shroud including a bore, said shroud enclosing the fan;
wherein the shroud is configured to direct airflow through the bore and over the one or more fins.

15. The generator of claim 14, wherein the fan comprises a radial fan.

16. The generator of claim 1, further comprising a voltage regulator.

17. A generator, comprising:
(a) a rotor assembly, comprising:
(i) a shaft;
(ii) a main rotor, including one or more main rotor poles, mounted on the shaft;
(iii) one or more main rotor windings wound around the one or more main rotor poles and operative to produce a time-varying magnetic field; and
(iv) one or more rings disposed at one or both ends of the main rotor;
wherein the one or more rings are configured to impart a clamping force to secure the one or more main rotor windings to the one or more main rotor poles while conforming to the one or more main rotor winding's profiles;
(b) a rectifier assembly, comprising:
(i) a rectifier housing including a heat sink, wherein the heat sink comprises one or more flat surfaces and one or more fins; and
(ii) one or more rectifiers radially coupled with the one or more flat surfaces of the heat sink;
wherein the one or more rectifiers are configured to dissipate heat directly into the one or more fins; and
(c) a cooling assembly, comprising:
(i) a fan mounted on the shaft and adjacent to the rectifier assembly; and
(ii) a shroud including a bore, said shroud enclosing the fan;
wherein the shroud is configured to direct airflow through the bore and over the one or more fins.

18. A generator, comprising:
(a) a drive-end housing, comprising:
(i) a main stator assembly disposed therein; and
(ii) a first bore concentric to an outer diameter of the drive-end housing, said first bore enclosing a first bearing disposed therein;
(b) an anti-drive-end housing, comprising:
(i) an exciter stator assembly disposed therein; and
(ii) a second bore concentric to an outer diameter of the anti-drive-end housing, said second bore enclosing a second bearing disposed therein;
(c) a rectifier assembly comprising one or more rectifiers operative to convert alternating current generated by the main stator assembly into direct current;
(d) a rotor assembly disposed between the first and second bearing, said rotor assembly comprising:
(i) a shaft inserted in the first and second bearing;
(ii) a main rotor, including one or more main rotor poles, mounted on the shaft;
(iii) one or more main rotor windings wound around the one or more main rotor poles and operative to produce a time-varying magnetic field;
(iv) an exciter rotor assembly operative to generate field current in the main rotor windings via the exciter stator assembly; and
(v) one or more rings disposed at one or both ends of the main rotor;
wherein the one or more rings are configured to impart a clamping force to secure the one or more main rotor windings to the one or more main rotor poles while conforming to the one or more main rotor winding's profiles; and
(e) a cooling assembly comprising:
(i) a fan mounted on the shaft; and
(ii) a shroud including a third bore, said shroud enclosing the fan;
wherein the cooling assembly is configured to direct airflow in the direction from the anti-drive-end housing to the drive-end housing; and
wherein the elements (a) through (e) are positioned as follows:
the anti-drive-end housing is disposed adjacent to the drive-end housing;
the rectifier assembly is disposed adjacent to the anti-drive-end housing;
the rotor assembly is enclosed within the drive-end housing and anti-drive-end housing;
the main rotor is disposed between the drive-end housing and the exciter rotor assembly; and
the cooling assembly is disposed adjacent to the rectifier assembly.

19. The generator of claim 18, wherein the anti-drive-end housing further comprises two output terminals, and wherein the generator further comprising a voltage regulator operative to regulate output voltages of the two output terminals at a regulation voltage.

20. The generator of claim 19, wherein the two output terminals are electrically isolated from each other.
